(19) United States
(12) Patent Application Publication
(10) Pub. No.: US 2024/0306854 A1
(43) Pub. Date: Sep. 19, 2024

(54) SKEWERS FOR HOLDING FOOD ITEMS

(71) Applicant: Volk Enterprises, Inc., Turlock, CA (US)

(72) Inventor: Daniel J. Volk, Cumming, GA (US)

(73) Assignee: Volk Enterprises, Inc., Turlock, CA (US)

(21) Appl. No.: 18/185,812

(22) Filed: Mar. 17, 2023

(51) Int. Cl. A47J 43/28; A47J 43/18

(52) U.S. Cl. CPC A47J 43/283; A47J 43/18

(57) ABSTRACT

A plastic skewer for holding food items helps prevent food items from rotating on the elongated stem of the skewer or sliding off of the stem of the skewer, is inexpensive to manufacture, and can be subjected to food heating or cooking temperatures without melting. The outer surface of the stem is unsmooth or roughened to help prevent the food item being held on the stem from rotating on the stem or sliding in the lengthwise direction of the stem.

### BACKGROUND OF THE INVENTION

### Technical Field

The present disclosure relates generally to the field of food preparation and consumption, and more particularly, to skewers for holding a wide variety of food items.

### Prior Art

The use of skewers for the purposes of holding or anchoring foods or the like to each other or together is very helpful in the preparation of food items such as entrees. Such skewers are used to hold meats or vegetables in place during cooking, as well as to skewer meat and vegetables together to be grilled for kabobs. As maintaining the position of food items or garnishes during cooking can be of paramount importance, especially in the preparation of expensive entrees or other dishes, the use of skewers has become prevalent in the food service industry.

Combinations of foods that can be combined using skewers are numerous and often selected so that these foods complement each other in taste. Such combinations can consist exclusively of meats, vegetables, or fruits, or can consist of any combinations thereof. Meats that can be used with skewers include for example beef tenderloin, partially fried and rolled up bacon slices, pieces of boneless chicken or turkey breast, pork cubes, ham cubes, lamb cubes, small meatballs, pieces of sausage, shrimp, scallops and other seafood chunks. To complement such meats, other foods can be cooked with the meats, including for example onions, zucchini or other summer squash, green, red or yellow peppers, carrots, small whole potatoes, fresh mushrooms, and firm cherry tomatoes. The combinations of foods that can be used with skewers are limitless.

Skewers in general are old in the art and range from simple sharpened rods to complex multi-component devices. U.S. Patent No. 504777 to Fischer discloses a skewer for closing fowl comprising a central stem that is formed by twisting two pieces of wire together, one of which is provided with a loop, and is used for closing fowl after the fowl has been filled (with stuffing, etc.). U.S. Pat. No. 1,113,929 to Brown discloses a meat clamp or skewer for securely retaining wrapped or rolled meat and that includes a straight shank formed with a flat pointed head having sharpened edges and an angular stop shoulder at the inner end of the head, with an enlarged handle, and with a compressible tension spring coiled about the shank.

U.S. Pat. No. 2,404,166 to Danilla discloses a device for use in roasting poultry that is a one-piece metallic structure with a sinusoidal shank that terminates at one end in a point and in a head shape at the other end. U.S. Pat. No. 2,622,268 to Glantzlin discloses a flat wooden holder or skewer that has a uniform thickness, has sides tapered along to a wedge-like tip and appears to have a structure that may help prevent rotation and may help prevent the device from sliding out of the food. U.S. Pat. No. 2,651,251 to Brown discloses a skewer for aiding in the cooking of a roast that has a unitary length of wire having a stiff shank portion that extends to a pointed end.

U.S. Pat. No. 2,557,890 to Perry discloses a skewer for holding a rolled roast having an elongated pin that is pointed at one end and pointed bars along the skewer lock so to maintain the skewer in place within a piece of meat. U.S. Pat. No. 3,709,141 to Schwartzstein discloses a heat transmitting device for conducting heat into the interior of a roast to aid in the rapid and more uniform cooking of the roast. U.S. Pat. No. 5,495,794 to Ulysse discloses a handheld utensil adapted to hold a vegetable such as a potato for peeling and comprises a handle and a taper rod like element that ends in a tip.

Another purpose of skewers is to hold a food item as it is being eaten. There is a need in the convenience food industry for skewers that are well suited for this purpose. Today, convenience foods are very popular and are an important part of many people's lives. People today generally have less time to prepare food in between their activities. In most households, parents have one or more children and both parents often have jobs outside of the household, which leaves less time for parents to prepare meals. When parents wake up in the morning, they typically ready the children for school and ready themselves for work. When parents get home from work, they often have to take children to various activities, such as sporting activities, music lessons, cheerleading practice, etc. These busy lifestyles often leave very little time for meal preparation and only small periods of time during which snacks and/or meal substitutions can be consumed.

Many convenience foods are made to be held in one hand as they are eaten while the user performs other tasks, such as driving a car, for example. Problems can arise when the food item is, for example, messy, coated with a surgery coating, and/or hot to the touch. In such cases, a skewer can be used to hold the foot item during consumption. For example, food items such as corn dogs, chicken kabobs, or popsicles are typically anchored on skewers that can be held in one hand during consumption of the food item.

Wooden skewers are typically used to hold food items that are intended to be held in one hand while they are consumed. However, using wood skewers presents problems. One problem with wood skewers is that because wood is porous, it can harbor bacteria. It is very difficult to ensure that wooden skewers are clean and bacteria free when they arrive from the supplier. Also, it is possible for bacterium in the wood to contaminate the food, which can result in health issues for the consumer. Another problem with wooden skewers is that they can break and splinter, potentially leaving sharp pieces of wood in the food item, which can harm the person eating the food item. Additionally, if a wooden skewer is used for reheating and/or barbecuing food, the wooded skewer can catch fire. For this reason, the makers of these wooden skewers recommend soaking the sticks in water for 30 to 60 minutes before subjecting them to heating with a heat source. This additional step is inconvenient, inefficient and costly for the person selling the product.

An alternative to wooden skewers is plastic skewers. Plastic skewers are normally used to hold fruit or other non-heated food items. One of the problems of using plastic skewers is that their surfaces are typically smooth and round, which can result in the food item spinning as the consumer tries to eat the food item and/or sliding off of the skewer into the consumer's lap or onto the floor. Plastic skewers sometimes have square cross-sections that help prevent the food item from spinning, but such skewers still have smooth surfaces that allow the food items to slide off of the skewers. Another problem with using plastic skewers is that because they are normally made of extruded plastic, they generally cannot have a round surface for the stem of the skewer mated to a flat surface for the handle that the fingers grip. Another problem with existing plastic skewers is that they generally cannot be used in an oven and/or on a barbecue grill because doing so will melt the skewer.

Metal skewers are also available in the market, but they generally are not a cost-effective alternative to wood or plastic. Additionally, as most convenience food items are scanned with metal detectors to check for foreign materials that may enter the foods during production, metal skewers generally are not suitable for holding convenience food items.

Due to one or more of the problems associated with known skewers intended to be used for holding items during consumption, some companies have made decisions to not participate in the growing convenience food industry. Some companies view the use of such skewers as exposing them to potential legal liability.

Accordingly, a need exists for an improved skewer for holding food items that prevents food items from spinning or sliding off of the skewer, that is cost effective, and that can be subjected to food heating or cooking temperatures without melting.

### BRIEF SUMMARY OF THE INVENTION

Briefly described, the present disclosure is directed to a skewer for holding one or more food items that prevents food items from spinning or sliding off of the skewer, that is relatively inexpensive to manufacture, and that can be subjected to food heating or cooking temperatures without melting. The skewer comprises a finger grip and an elongated stem. The finger grip has a proximal end, a distal end, and a finger-gripping portion disposed in between the proximal end and the distal end. The finger grip comprises a plastic material that can be subjected to a range of food heating temperatures without melting. The elongated stem has a proximal end, a distal end, and an outer surface. The proximal end of the stem is secured to the distal end of the finger grip. The distal end of the elongated stem is configured to pierce a food item and the elongated stem is configured to allow a desired length of the stem to be passed through the food to position the food item on the elongated stem. The outer surface of the stem is unsmooth to help prevent the food item being held on the stem from rotating on the stem or sliding in the lengthwise direction of the stem. The stem comprising a plastic material that can be subjected to a range of food heating temperatures without melting.

These and other features and advantages of the invention will become apparent from the following description, drawings, and claims.

### BRIEF DESCRIPTION OF THE DRAWINGS

FIGS. 1A-1C are top, side and distal end views, respectively, of the skewer in accordance with a representative embodiment.

FIGS. 2A-2C are top, side and distal end views, respectively, of the skewer in accordance with another representative embodiment.

FIG. 3 is a top plan view of the skewer in accordance with another representative embodiment.

FIG. 4 is a top plan view of the skewer in accordance with another representative embodiment.

FIG. 5 is a top plan view of the skewer in accordance with another representative embodiment.

FIG. 6 is a top plan view of the skewer in accordance with another representative embodiment.

FIGS. 7A-7D are side, top, distal end plan, and distal end perspective views, respectively, of the skewer in accordance with another representative embodiment.

FIGS. 8A-8C are side perspective, distal end plan, and cross-sectional views, respectively, of the skewer in accordance with another representative embodiment.

FIGS. 9A-9C are side plan, side perspective, and side cross-sectional views, respectively, of the skewer in accordance with another representative embodiment.

FIG. 10 is a side cross-sectional view of the skewer 100 in accordance with another representative embodiment.

### DETAILED DESCRIPTION OF PREFERRED EMBODIMENTS

The present invention provides an improved skewer for holding food items that prevents food items from spinning or sliding off of the skewer, that is inexpensive to manufacture, and that can be subjected to food heating or cooking temperatures without melting. Representative embodiments of the skewer are described below with reference to the drawings.

In the following detailed description, several exemplary, or representative, embodiments of the generic inventive concept are described to demonstrate the inventive principles and concepts. For purposes of explanation and not limitation, representative embodiments disclosing specific details are set forth in order to provide a thorough understanding of an embodiment according to the present disclosure. However, it will be apparent to one having ordinary skill in the art having the benefit of the present disclosure that other embodiments that depart from the specific details disclosed herein remain within the scope of the appended claims. Moreover, descriptions of well-known apparatuses and methods may be omitted so as to not obscure the description of the representative embodiments. Such methods and apparatuses are clearly within the scope of the present disclosure.

The terminology used herein is for purposes of describing particular embodiments only, and is not intended to be limiting. The defined terms are in addition to the technical and scientific meanings of the defined terms as commonly understood and accepted in the technical field of the present teachings.

As used in the specification and appended claims, the terms “a”, “an”, and “the” include both singular and plural referents, unless the context clearly dictates otherwise. Thus, for example, “a device” includes one device and plural devices.

Relative terms may be used to describe the various elements' relationships to one another, as illustrated in the accompanying drawings. These relative terms are intended to encompass different orientations of the device and/or elements in addition to the orientation depicted in the drawings. For example, terms such as “over”, “above”, “below”, “top”, “bottom”, “front”, “back”, “upper”, “lower”, “left side”, “right side” may be used to describe the various elements' relationships to one another, as illustrated in the accompanying drawings. These relative terms are intended to encompass different orientations of the device and/or elements in addition to the orientation depicted in the drawings. For example, if the device were inverted with respect to the view in the drawings, an element described as “above” another element, would now be below that element.

The terms “substantial” or “substantially” mean to within acceptable limits or degrees acceptable to those of skill in the art. For example, the terms “substantially parallel to” or “generally parallel to” mean that a structure or device may not be made perfectly parallel to some other structure or device due to tolerances or imperfections in the process by which the structures or devices are made. Likewise, the terms “substantially perpendicular to” or “generally perpendicular to” mean that a structure or device may not be made perfectly perpendicular to some other structure or device due to tolerances or imperfections in the process by which the structures or devices are made. the term “generally round” means that a structure or device may not be made perfectly round due to tolerances or imperfections in the process by which the structures or devices are made. The terms “approximately” or “about” mean to within an acceptable limit or amount to one of ordinary skill in the art.

Where a first device is said to be connected or coupled to a second device, this encompasses examples where one or more intermediate devices may be employed to connect the two devices to each other. In contrast, where a first device is said to be directly connected or directly coupled to a second device, this encompasses examples where the two devices are connected together without any intervening devices other than connector devices or materials (e.g., bonding materials, mechanical fasteners, etc.).

Exemplary, or representative, embodiments will now be described with reference to the figures, in which like reference numerals represent like components, elements or features. It should be noted that features, elements or components in the figures are not intended to be drawn to scale, emphasis being placed instead on demonstrating inventive principles and concepts.

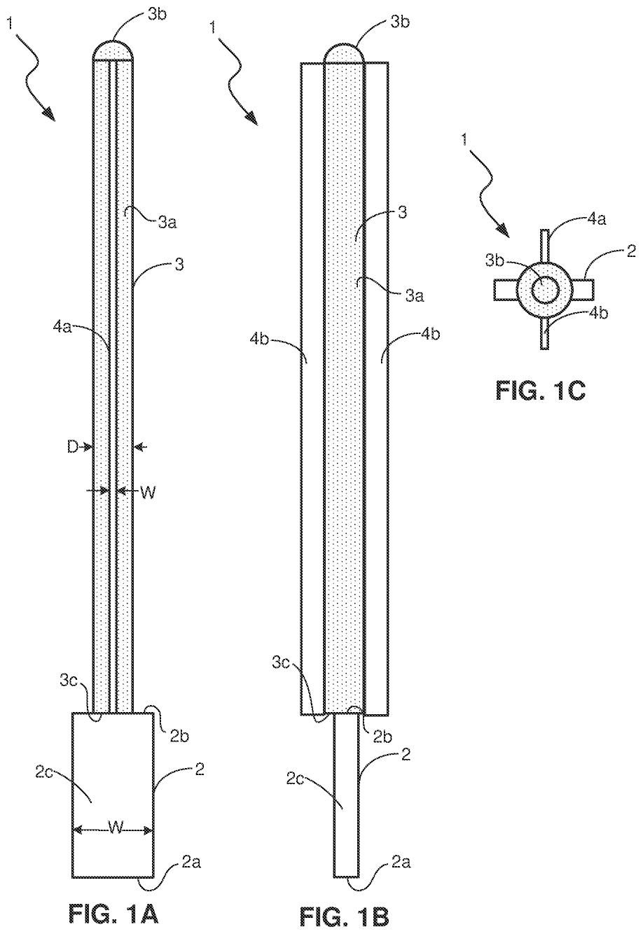

FIGS. 1A-1C are top, side, and distal end views, respectively, of the skewer 1 in accordance with a representative embodiment. In accordance with this representative embodiment, a finger grip 2 of the skewer 1 has a generally flat cross-section and the stem 3 of the skewer 1 has a generally round cross-section and a rough outer surface 3a with at least first and second fins 4a and 4b, respectively, projecting outwardly from the rough outer surface 3a in directions that are generally perpendicular to the lengthwise direction of the stem 3 and extending along the length of the stem 3 in directions that are generally parallel to the lengthwise direction of the stem 3. The outer surface 3a can be roughened by subjecting it to a sand blasting process or some other roughening process that forms openings in the outer surface 3a.

A distal end 3b of the stem 3 can be rounded or pointed to facilitate piercing the food item with the distal end 3b and passing a desired length of the stem 3 through the food item. The stem 3 and the fins 4a, 4b preferably are made of a relatively hard plastic material that can withstand temperature ranges commonly used for heating or reheating food items. A preferred material for the stem 3 is an engineered heat-stable NYLON® 6/6 material or a like material that can withstand temperature ranges commonly used for cooking, heating, or reheating food items, such as A-B degrees F., and more preferably C-D degrees F.

In embodiments in which roughening of the outer surface 3a of the stem 3 is used to prevent spinning of the food item on the stem 3 and/or to prevent slipping of the food item from the stem 3, the material comprising the stem 3 should be capable of being subjected to a roughening process such as sand blasting, for example. Other than sand blasting, other processes that can be used to roughen the outer surface of the stem 3 include abrasion, machining, graining, lapping, laser etching, and chemical etching. It is preferable to have a surface roughness sufficient to inhibit or prevent the rotation or sliding of the food item on the stem 3. A sufficient roughness can be determined by one of ordinary skill in the art without undue experimentation. The stem 3 can have an X-pattern cut, knifed, or otherwise formed in the surface of the stem 3 as or instead of a roughened surface, as such an X-pattern will inhibit or prevent the food item from turning or sliding on the stem 3. Alternatively or additionally, the fins 4a, 4b can have ridges or roughened surfaces. Also alternatively or additionally, one can put the food item onto the stem 3 in a raw state, as when such a food item is cooked, it generally will shrink and fits tighter on the stem 3.

Examples of other plastic materials that can be used for the stem 3 include high density polyethylene, polystyrene, and polypropylene, which are suitable for higher temperature applications, such as cooked meats. For cold food items, or room temperature food items, one can use a less costly food grade material such as polycarbonate, polyethylene terephthalate.

The finger grip 2 preferably is also made of a relatively hard plastic material, such as NYLON® 6/6 material, for example. The finger grip 2 and the stem 3 can be made of the same plastic material or of different plastic materials. The finger grip 2 and the stem 3 are not limited in terms of their dimensions, shapes, or cross sections. In some embodiments, the stem 3 has a generally round cross section while in other embodiments the stem 3 has a generally rectangular or generally flat cross-section. Likewise, in some embodiments, the finger grip 2 has a generally round cross section while in other embodiments the finger grip 2 has a generally rectangular or generally flat cross-section.

In accordance with the representative embodiment shown in FIGS. 1A-1C, after the skewer 1 is manufactured, the stem 3 is subjected to a sand blasting process that roughens to outer surface 3a of the stem 3. As indicated above, roughening the outer surface 3a helps prevent the food item from spinning on the stem 3 or slipping off of the stem 3. The fins 4a and 4b also helps prevent the food item from spinning on the stem 3 or slipping off of the stem 3. The fins 4a and 4b may be sufficient to prevent or help reduce spinning and slippage, in which case it may not be necessary for the outer surface 3a of the stem 3 to be rough. Conversely, the rough outer surface 3a of the stem 3 may be sufficient to prevent or help reduce spinning and slippage, in which case it may not be necessary for the stem 3 to have fins 4a.

As indicated above, the finger grip 2 and the stem 3 are not limited to having any particular dimensions, shapes or cross sections. An example of suitable dimensions for the finger grip 2 and stem 3 having the configurations shown in FIGS. 1A-1C are: a diameter, D, of about 0.10 inches for the stem 3; a width, W, of about 0.03 inches for each of the fins 4a and 4b; and a width, W, of about 0.25 inches for the finger grip 2. The overall length of the skewer 1 and the length of the stem 3 will generally be chosen based on the type of food item(s) with which the skewer 1 is intended to be used.

The finger grip 2 has a proximal end 2a, a distal end 2b, and a finger-gripping portion 2c that extends from the proximal end 2a to the distal end 2b. Likewise, the stem 3 has a proximal end 3c opposite the distal end 3b. The stem 3 extends from the proximal end 3c to the distal end 3b. The proximal end 3c of the stem 3 is secured to the distal end 2b of the finger grip 2.

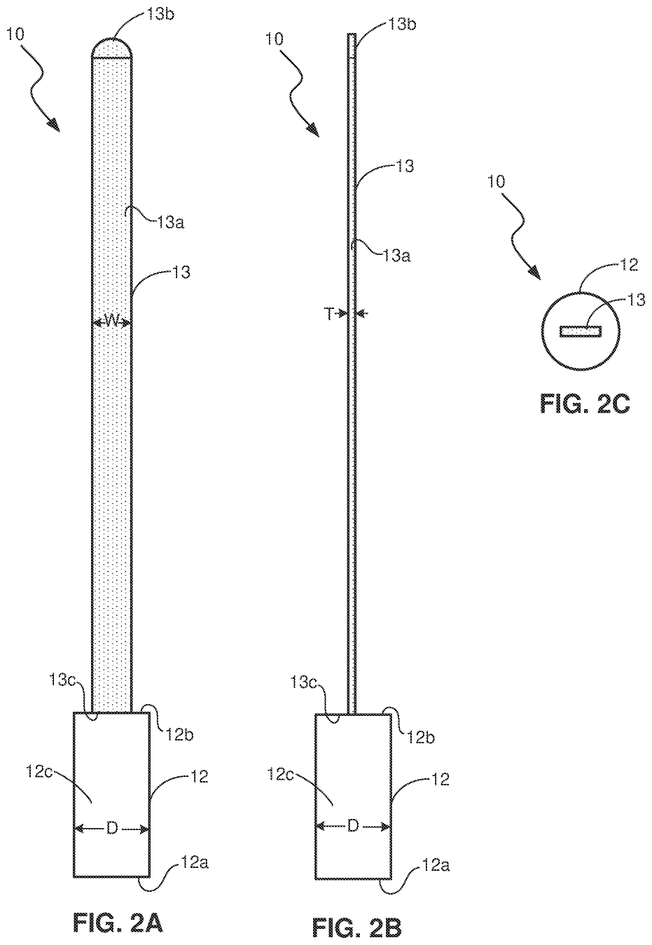

FIGS. 2A-2C are top, side, and distal end views, respectively, of the skewer 10 in accordance with a representative embodiment. In accordance with this representative embodiment, a finger grip 12 of the skewer 10 has a generally flat cross-section and the stem 13 of the skewer 10 has a generally round cross-section and a rough outer surface 13a along the length of the stem 3. A distal end 13b of the stem 13 is shown as being rounded, but it can be rounded or pointed to facilitate piercing the food item with the distal end 13b and passing a desired length of the stem 13 through the food item.

Like the stem 3 shown in FIGS. 1A-1C, the stem 13 preferably is made of a relatively hard plastic material that can withstand temperature ranges commonly used for heating or reheating food items, such as an engineered heat-stable NYLON® 6/6 material or a like material. In accordance with this embodiment, the flat shape of the stem 13 in combination with the roughened outer surface 13a of the stem 13 help prevent spinning of the food item on the stem 13 and/or slipping of the food item from the stem 13. This combination obviates the need for the fins 4a, 4b shown in FIGS. 1A-1C or other features that protrude outwardly from the stem 13 to help prevent spinning of the food item on the stem 13 and/or slipping of the food item from the stem 13.

The finger grip 12, which in this embodiment is round, preferably is also made of a relatively hard plastic material, such as NYLON® 6/6 material, for example. The finger grip 12 and the stem 13 can be made of the same plastic material or of different plastic materials. The finger grip 12 and the stem 13 are not limited in terms of their dimensions, shapes, or cross sections. In some embodiments, the finger grip 12 has a generally rectangular or generally flat cross-section instead of a generally round cross section.

As with the embodiment shown in FIGS. 1A-1C, in accordance with this representative embodiment, after the skewer 10 is manufactured, the stem 13 is subjected to a sand blasting process that roughens to outer surface 13a of the stem 13. As indicated above, roughening the outer surface 13a helps prevent the food item from spinning on the stem 13 or slipping off of the stem 13. Processes other than sand blasting can also be used for this purpose, as will be understood by those of skill in the art in view of the description provided herein.

As indicated above, the finger grip 12 and the stem 13 are not limited to having any particular dimensions, shapes, or cross sections. An example of suitable dimensions for the finger grip 12 and stem 13 having the configurations shown in FIGS. 2A-2C are: a width, W, of about 0.10 inches for the stem 13; a thickness, T, of about 0.03 inches for the stem 13; and a diameter, D, of about 0.25 inches for the finger grip 12. The overall length of the skewer 10 and the length of the stem 13 will generally be chosen based on the type of food item(s) with which the skewer 10 is intended to be used.

The finger grip 12 has a proximal end 12a, a distal end 12b, and a finger-gripping portion 12c that extends from the proximal end 12a to the distal end 12b. Likewise, the stem 13 has a proximal end 13c opposite the distal end 13b. The stem 13 extends from the proximal end 13c to the distal end 13b. The proximal end 13c of the stem 13 is secured to the distal end 12b of the finger grip 12.

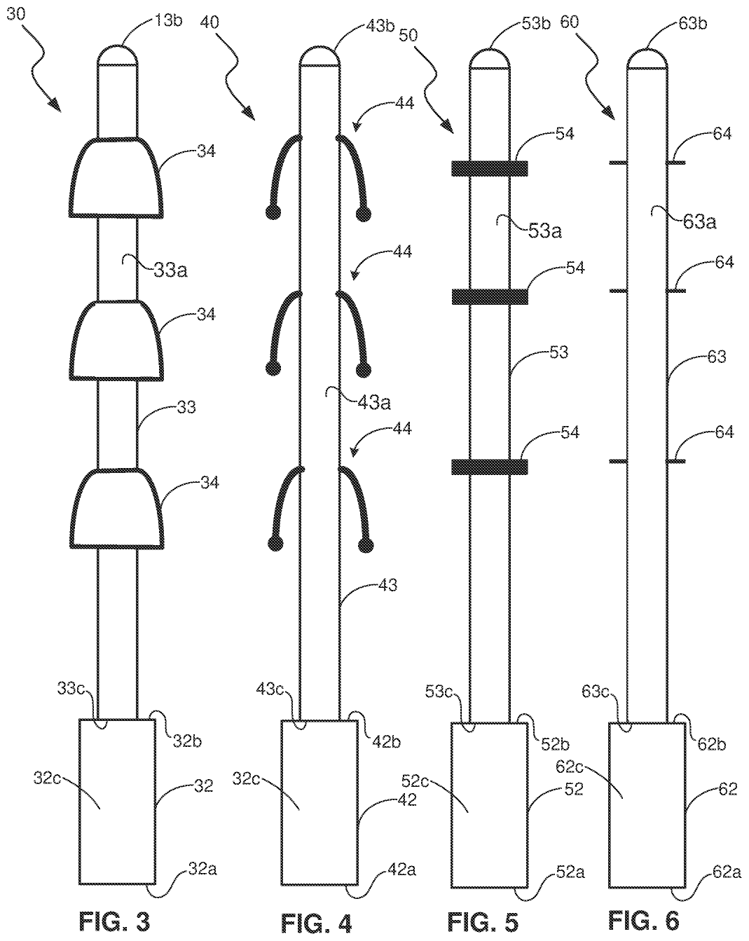

FIG. 3 is a top plan view of the skewer 30 in accordance with a representative embodiment in which the finger grip 32 of the skewer 30 can have a round, rectangular, or flat cross-section. Likewise, the stem 33 of the skewer 30 can have a round, rectangular, or flat cross-section. In accordance with this representative embodiment, one or more inverted cones 34 disposed on the stem 33 extend outwardly and downwardly from the stem 33. The outer surface 33a of the stem 33 can be, but is not required to be, roughened by sand blasting or some other roughening process as the outwardly and downwardly extending cones 34 perform the functions of helping to prevent one or more food items disposed on the stem 33 from spinning about or slipping from the stem 33.

The finger grip 32 has a proximal end 32a, a distal end 32b, and a finger-gripping portion 32c that extends from the proximal end 32a to the distal end 32b. Likewise, the stem 33 has a proximal end 33c opposite the distal end 33b. The stem 33 extends from the proximal end 33c to the distal end 33b. The proximal end 33c of the stem 33 is secured to the distal end 32b of the finger grip 32.

FIG. 4 is a top plan view of the skewer 40 in accordance with a representative embodiment in which the finger grip 42 of the skewer 40 has a round, rectangular, or flat cross-section and the stem 43 of the skewer 40 has a round, rectangular, or flat cross-section with one or more pairs of curved prongs 44 disposed thereon that extend outwardly and downwardly from the stem 43. The outer surface 43a of the stem 43 can be, but is not required to be, roughened by sand blasting or some other roughening process as the outwardly and downwardly extending prongs 44 perform the functions of helping to prevent one or more food items disposed on the stem 43 from spinning about or slipping from the stem 43.

The finger grip 42 has a proximal end 42a, a distal end 42b, and a finger-gripping portion 42c that extends from the proximal end 42a to the distal end 42b. Likewise, the stem 43 has a proximal end 43c opposite the distal end 43b. The stem 43 extends from the proximal end 43c to the distal end 43b. The proximal end 43c of the stem 43 is secured to the distal end 42b of the finger grip 42.

FIG. 5 is a top plan view of the skewer 50 in accordance with a representative embodiment in which the finger grip 52 of the skewer 50 has a round, rectangular, or flat cross-section and the stem 53 of the skewer 50 has a round, rectangular, or flat cross-section with one or more rings 54 disposed thereon that extend outwardly from and generally perpendicular to the lengthwise direction of the stem 53.

The outer surface 53a of the stem 53 can be, but is not required to be, roughened by sand blasting or some other roughening process as the outwardly extending rings 54 perform the functions of helping to prevent one or more food items disposed on the stem 53 from spinning about or slipping from the stem 53.

FIG. 6 is a top plan view of the skewer 60 in accordance with a representative embodiment in which the finger grip 62 of the skewer 60 has a round, rectangular, or flat cross-section and the stem 63 of the skewer 60 has a round, rectangular, or flat cross-section with one or more protrusions 64 disposed thereon that extend outwardly from and generally perpendicular to the lengthwise direction of the stem 63.

The outer surface 63a of the stem 63 can be, but is not required to be, roughened by sand blasting or some other roughening process as the outwardly extending protrusions 64 perform the functions of helping to prevent one or more food items disposed on the stem 63 from spinning about or slipping from the stem 63.

The finger grip 62 has a proximal end 62a, a distal end 62b, and a finger-gripping portion 62c that extends from the proximal end 62a to the distal end 62b. Likewise, the stem 63 has a proximal end 63c opposite the distal end 63b. The stem 63 extends from the proximal end 63c to the distal end 63b. The proximal end 63c of the stem 63 is secured to the distal end 62b of the finger grip 62.

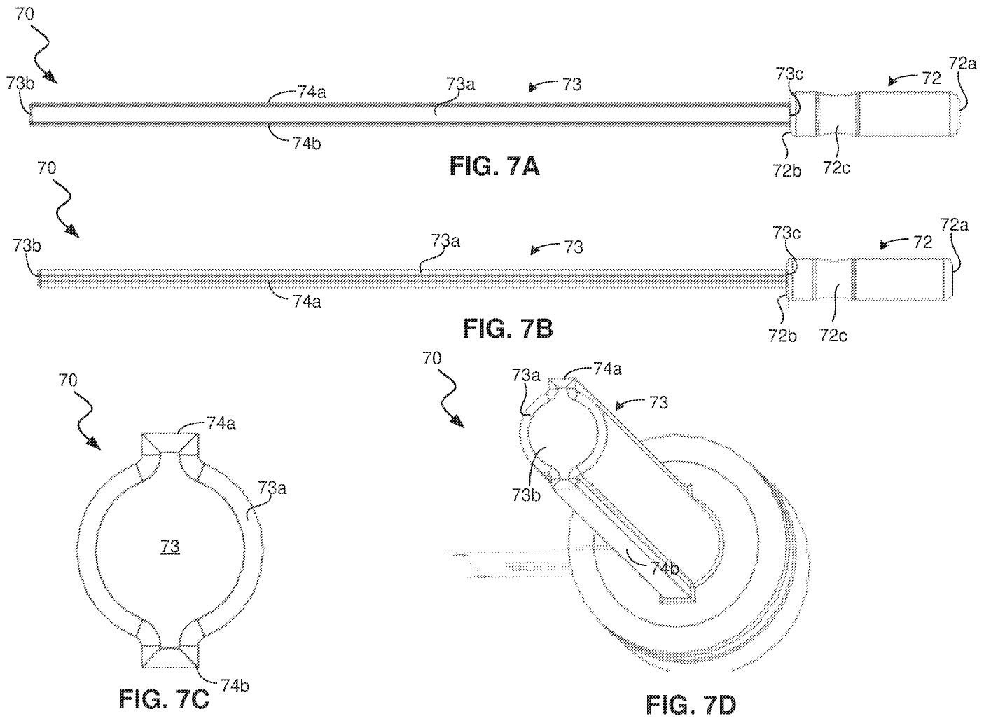

FIGS. 7A-7D are side, top, distal-end plan, and distal-end perspective views, respectively, of the skewer 70 in accordance with a representative embodiment. In accordance with this representative embodiment, the finger grip 72 of the skewer 70 has a generally round cross-section and the stem 73 of the skewer 70 has a generally round cross-section with at least first and second fins 74a and 74b, respectively, projecting outwardly from the outer surface 73a in directions that are generally perpendicular to the lengthwise direction of the stem 73 and extending along the length of the stem 73 in directions that are generally parallel to the lengthwise direction of the stem 73, similar to the stem configuration shown in FIGS. 1A-1 C.

The skewer configuration shown in FIGS. 7A-7D has essentially the same benefits as the skewer 1 shown in FIGS. 1A-1C. The outer surface 73a of the stem 73 can be, but need not be, roughened to help the skewer 70 perform the functions of preventing the food item(s) from spinning on the stem 73 or slipping off of the stem 73. The fins 74a and 74b perform the function of helping to prevent the food item(s) from spinning on the stem 73 and/or slipping off of the stem 73.

The finger grip 72 has a proximal end 72a, a distal end 72b, and a finger-gripping portion 72c that extends from the proximal end 72a to the distal end 72b. Likewise, the stem 73 has a proximal end 73c opposite the distal end 73b. The stem 73 extends from the proximal end 73c to the distal end 73b. The proximal end 73c of the stem 73 is secured to the distal end 72b of the finger grip 72.

In accordance with this representative embodiment the finger-gripping portion 72c has a surface profile that curves inwardly at a location in between the proximal end 72a and the distal end 72b of the finger grip 72 to facilitate gripping of the portion 72c with the fingers of the user.

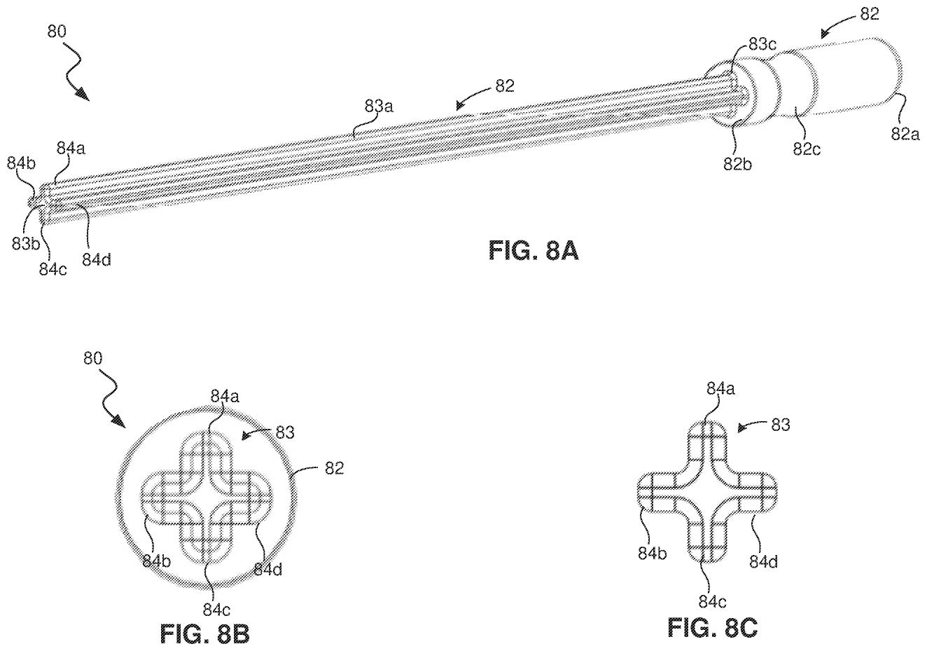

FIGS. 8A-8C are side perspective, distal end plan, and cross-sectional views, respectively, of the skewer 80 in accordance with a representative embodiment. In accordance with this representative embodiment, the finger grip 82 of the skewer 80 has a generally round cross-section and the stem 83 of the skewer 83 has a generally cross-shaped cross-section with the cross-shaped cross-section comprising at least first, second, third, and fourth ribs 84a, 84b, 84c, and 84d, respectively, projecting outwardly from the outer surface of the stem 83 in directions that are generally perpendicular to the lengthwise direction of the stem 83 and extending along the length of the stem 83 in directions that are generally parallel to the lengthwise direction of the stem 83.

The directions in which the first and third ribs 84a and 84c, respectively, project outwardly are parallel to one another and are perpendicular to the directions in which the second and fourth ribs 84b and 84d, respectively, project outwardly. Likewise, the second and fourth ribs 84b and 84d, respectively, project outwardly in directions that are parallel to one another. The outer surface 83a of the stem 83 can be, but need not be, roughened to help the skewer 80 perform the functions of preventing the food item(s) from spinning on the stem 83 or slipping off of the stem 83. The ribs 84a-84d perform the function of helping to prevent the food item(s) from spinning on the stem 83 and/or slipping off of the stem 83.

The finger grip 82 has a proximal end 82a, a distal end 82b, and a finger-gripping portion 82c that extends from the proximal end 82a to the distal end 82b. Likewise, the stem 83 has a proximal end 83c opposite the distal end 83b of the stem 83. The stem 83 extends from the proximal end 83c to the distal end 83b. The proximal end 83c of the stem 83 is secured to the distal end 82b of the finger grip 82.

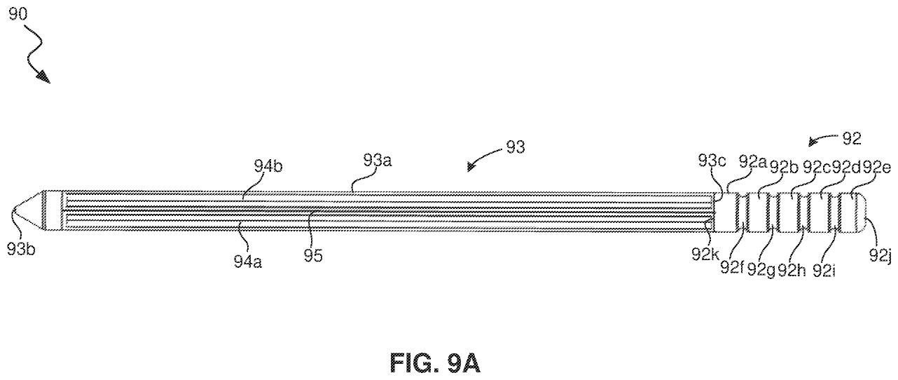

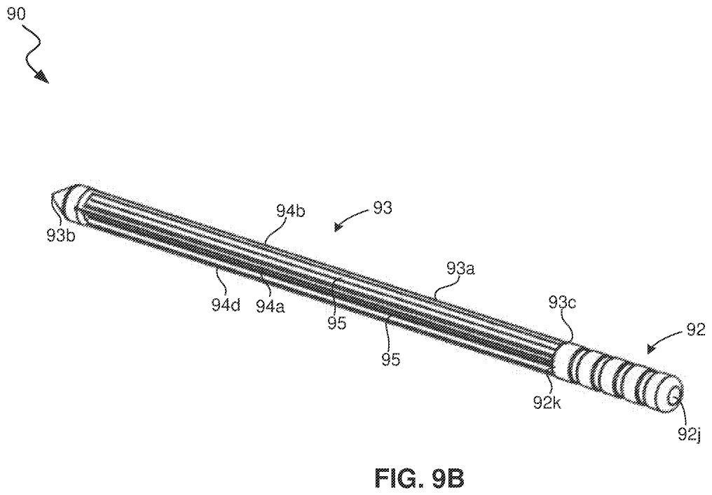

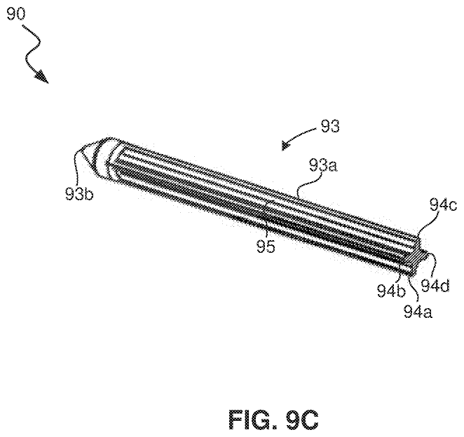

FIGS. 9A-9C are side plan, side perspective, and side cross-sectional views, respectively, of the skewer 90 in accordance with a representative embodiment. In accordance with this representative embodiment, the finger grip 92 of the skewer 90 comprises five rings 92a-92e that are interconnected by ring connecting portions 92f-92i that are smaller in diameter than the diameters of the rings 92a-92e. The rings 92a-92e help the skewer 90 to cool by dissipating heat in a manner similar to the manner in which fins on a radiator help dissipate heat. The rings 92a-92e also facilitate gripping with fingers.

The ring 92a also assists in making sure the skewer inserts straight into the food item. The smaller diameters of the ring connecting portions 92f-92i can cause the skewer 90 to bend slightly in one direction or the other if part of the food item passes into the grooves between the rings 92a-92e created by the smaller diameters of the ring connecting portions 92f-91i. The ring 92a helps prevent this.

The finger grip 92 has a proximal end 92j, a distal end 92k and the interconnected rings 92a-92e extending from the proximal end 92j to the distal end 92k. The stem 93 has a proximal end 93c opposite the distal end 93b of the stem 93. The stem 93 extends from the proximal end 93c to the distal end 93b. The proximal end 93c of the stem 93 is secured to the distal end 92k of the finger grip 92.

As can be seen best in FIG. 9C, the stem 93 of the skewer 90 has a generally cross-shaped cross-section with the cross-shaped cross-section comprising at least first, second, third, and fourth ribs 94a, 94b, 94c, and 94d, respectively, projecting outwardly from the outer surface of the stem 93 in directions that are perpendicular to the lengthwise direction of the stem 93 and extending along the length of the stem 93 in directions that are parallel to the lengthwise direction of the stem 93. Additionally, in accordance with this embodiment, the stem 93 has grooves 95 formed in its outer surface 93a in between the ribs 94a-94d that extending along the length of the stem 93 generally parallel to the lengthwise direction of the ribs 94a-94d.

The first and third ribs 94a and 94c, respectively, project outwardly in directions that are generally parallel to one another and generally perpendicular to the directions in which the second and fourth ribs 94b and 94d, respectively, project outwardly. Likewise, the second and fourth ribs 94b and 94d, respectively, project outwardly in directions that are generally parallel to one another. The outer surface 93a of the stem 93 can be, but need not be, roughened to help the skewer 90 perform the functions of preventing the food item(s) from spinning on the stem 93 or slipping off of the stem 93. The ribs 94a-94d and the grooves 95 perform the function of helping to prevent the food item(s) from spinning on the stem 93 and/or slipping off of the stem 93.

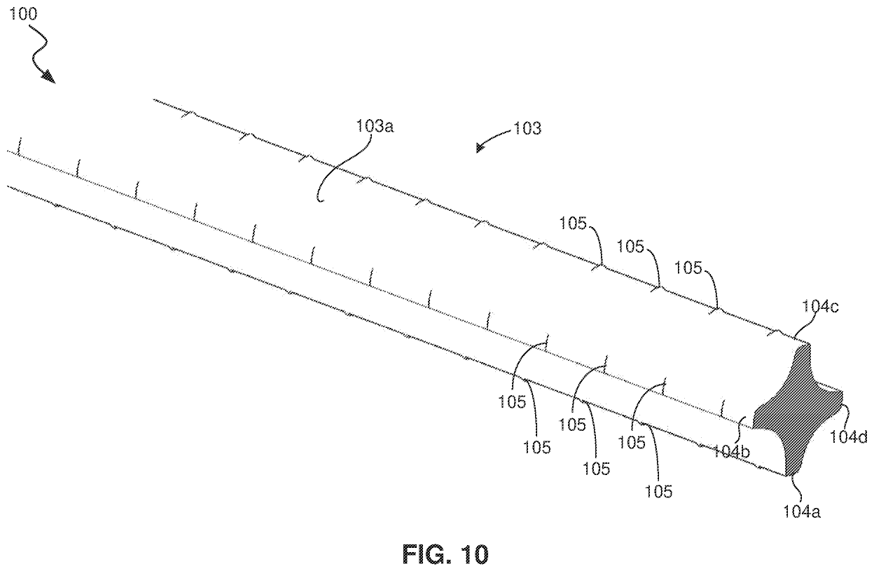

FIG. 10 is a side cross-sectional view of the skewer 100 in accordance with a representative embodiment in which the skewer 100 has the same configuration as the skewer 90 shown in FIGS. 9A-9C except that the skewer 100 does not include the grooves 95 shown in FIGS. 9A-9C and the ribs 104a-104d of the skewer 100 have serrated edges 105. The first, second, third, and fourth ribs 104a, 104b, 104c, and 104d, respectively, project outwardly from the outer surface 103a of the stem 103 in directions that are generally perpendicular to the lengthwise direction of the stem 103 and extending along the length of the stem 103 in directions that are parallel to the lengthwise direction of the stem 103. The serrations 105 also project outwardly from the outer surface 103a of the stem 103 in directions that are generally perpendicular to the lengthwise direction of the stem 103 and extend along the length of the stem 103. The outer surface 103a of the stem 103 can be, but need not be, roughened to help the skewer 100 perform the functions of preventing the food item(s) from spinning on the stem 103 or slipping off of the stem 103. The ribs 104a-104d and the serrations 105 perform the function of helping to prevent the food item(s) from spinning on the stem 103 and/or slipping off of the stem 103.

It should be noted that representative, or exemplary, embodiments have been shown and described herein for purposes of demonstrating the inventive principles and concepts and that the present invention is not limited to these representative embodiments. All of these embodiments have in common that the stem comprises a plastic material and has an unsmooth outer surface attributable to the outer surface being roughened by subjecting it to some type of roughening process (e.g., sand blasting, etching, etc.) and/or by forming protruding structures (e.g., ribs, ridges, fins, rings, prongs, cones, etc.) in or on the outer surface that cause the profile of the outer surface to vary frequently over the length of the stem. The unsmooth outer surface of the plastic stem helps prevent food item(s) from spinning about the stem and from slipping off of the stem. Using a plastic material for this purpose that can withstand temperature ranges commonly used for heating or reheating food items allows this non-spin, non-slip function to be achieved while also achieving the goals of providing a skewer that can be subjected to relatively high temperatures and keeping manufacturing costs low.

The foregoing detailed description of the preferred embodiments and the appended figures have been presented only for illustrative and descriptive purposes. They are not intended to be exhaustive and are not intended to limit the scope of the invention. The embodiments were selected and described to best explain the inventive principles and concepts and the manner in which they can be applied to practical applications. One skilled in the art will recognize that many variations can be made to the embodiments disclosed herein without departing from the scope of the invention.

What is claimed is:

1. A skewer for holding one or more food items, the skewer comprising:
a finger grip having a proximal end, a distal end, and a finger-gripping portion disposed in between the proximal end and the distal end, the finger grip comprising a plastic material that can be subjected to a range of food heating temperatures without melting; and
an elongated stem having a proximal end, a distal end, and an outer surface, the proximal end of the stem being secured to the distal end of the finger grip, the distal end of the elongated stem being configured to pierce a food item, and the elongated stem being configured to allow a desired length of the stem to be passed through the food to position the food item on the elongated stem, the stem having features formed in the outer surface of the stem that are configured to help prevent a food item being held on the stem from rotating on the stem or sliding in a lengthwise direction of the stem, the stem comprising a plastic material that can be subjected to a range of food heating temperatures without melting.

2. The skewer of claim 1, wherein the plastic material comprising the finger grip is the same as the plastic material comprising the elongated stem.

3. The skewer of claim 2, wherein the plastic material comprising the finger grip and the elongated stem is a NYLON® material.

4. The skewer of claim 1, wherein the features include breaks formed in the outer surface of the elongated stem by subjecting the stem to a roughening process that removes portions of the outer surface of the stem along a length of the stem to form the openings.

5. The skewer of claim 1, wherein the features comprise at least one structure projecting outwardly from the outer surface of the stem and extending along a length of the stem.

6. The skewer of claim 5, wherein said one or more structures comprise at least a first fin that projects outwardly from the outer surface of the stem and extends along the length of the stem.

7. The skewer of claim 6, wherein said one or more structures comprise at least a second fin that projects outwardly from the outer surface of the stem and extends along the length of the stem.

8. The skewer of claim 5, wherein said one or more structures comprise at least a first inverted cone disposed at a first location along the length of the stem, the first inverted cone extending outwardly from the outer surface of the stem in a direction toward the proximal end of the stem.

9. The skewer of claim 8, wherein said one or more structures comprise at least a second inverted cone disposed at a second location along the length of the stem in between the first inverted cone and the proximal end of the stem, the second inverted cone extending outwardly from the outer surface of the stem in a direction toward the proximal end of the stem.

10. The skewer of claim 5, wherein said one or more structures comprise at least a first pair of prongs disposed at a first location along the length of the stem, the first pair of prongs extending outwardly from the outer surface of the stem in a direction toward the proximal end of the stem.

11. The skewer of claim 10, wherein said one or more structures comprise at least a second pair of prongs disposed at a second location along the length of the stem in between the first pair of prongs and the proximal end of the stem, the second pair of prongs extending outwardly from the outer surface of the stem in a direction toward the proximal end of the stem.

12. The skewer of claim 5, wherein said one or more structures comprise at least a first ring disposed at a first location along the length of the stem, the first ring projecting outwardly from the outer surface of the stem in a direction generally perpendicular to the lengthwise direction of the stem.

13. The skewer of claim 12, wherein said one or more structures further comprise at least a second ring disposed at a second location along the length of the stem in between the first ring and the proximal end of the stem, the second ring projecting outwardly from the outer surface of the stem in a direction generally perpendicular to the lengthwise direction of the stem.

14. The skewer of claim 5, wherein said one or more structures comprise at least a first protrusion disposed at a first location along the length of the stem, the first protrusion projecting outwardly from the outer surface of the stem in a direction generally perpendicular to the lengthwise direction of the stem.

15. The skewer of claim 14, wherein said one or more structures further comprise at least a second protrusion disposed at a second location along the length of the stem in between the first protrusion and the proximal end of the stem, the second protrusion projecting outwardly from the outer surface of the stem in a direction generally perpendicular to the lengthwise direction of the stem.

16. The skewer of claim 5, wherein said one or more structures comprises first, second, third, and fourth ribs projecting outwardly from the stem in directions that are generally perpendicular to a lengthwise direction of the stem and extending along a length of the stem.

17. The skewer of claim 16, wherein said one or more structures further comprise grooves formed in the stem in between the ribs, the grooves extending in the lengthwise direction of the stem.

18. The skewer of claim 16, wherein the finger grip comprises a plurality of rings that are interconnected by ring connecting portions that are smaller in diameter than diameters of the rings, and wherein the interconnected rings help the skewer dissipating heat.

19. The skewer of claim 16, wherein the first, second, third, and fourth ribs have serrations thereon that project outwardly from the stem in directions that are generally perpendicular to a lengthwise direction of the stem and extend along a length of the stem.
